(19) United States
(12) Patent Application Publication
(10) Pub. No.: US 2026/0087008 A1
(43) Pub. Date: Mar. 26, 2026

(54) INTELLIGENT DATASTORE SEARCH USING LIVE EMBEDDING

(71) Applicant: SAP SE, Walldorf (DE)

(72) Inventors: Asma Naqvi, Ravensburg (DE); Andreas Engel, Weinheim (DE)

(21) Appl. No.: 18/894,344

(22) Filed: Sep. 24, 2024

(51) Int. Cl. G06F 16/2453; G06F 16/248

(52) U.S. Cl. CPC G06F 16/24542; G06F 16/248

(57) ABSTRACT

This disclosure describes systems, software, and computer implemented methods for taking a user's natural language query, using a generative AI model to produce an embedding of that query, and then comparing that query embedding to a database of embeddings generated from metadata and data set descriptions of the datasets in the datastore. This database of embeddings includes both the embedding vectors, and a metadata object describing each data set in the datastore and is uniquely generated to enable efficient search application. Once comparison results are determined, the closest matching datasets to the user query can be provided to the AI model for a summarization of their contents, before being returned to the user as search results.

### BACKGROUND

Some data repositories contain vast amounts of data sets that can be used in constructing data models and combined data sets for use in analytics or by data scientists. However, each data set may provide varied information about what is contained in the data set. Further, that information is often provided in different formats and with different degrees of detail. Finding data sets that are useful in building a particular data model or combined data sets requires an intelligent search functionality that will permit the user to quickly and easily locate applicable data sets.

### SUMMARY

The present disclosure involves systems, software, and computer implemented methods for performing intelligent datastore search including receiving a search query in a natural language from a device associated with a user; converting the search query to a first artificial intelligence (AI) prompt; sending the AI prompt to an AI model; receiving, from the AI model, a query embedding representing the search query; performing a similarity search between the query embeddings and a database of embeddings to identify one or more candidate results, wherein the database of embeddings includes a plurality of entries, each entry including a metadata object describing available data, and a previously generated embedding associated with the available data; selecting, from the one or more candidate results, a search result; and sending the search result to the device associated with the user.

Implementations can optionally include one or more of the following features.

In some instances, operations include sending a data ID from the metadata object for each of the one or more candidate results and a second AI prompt to the AI model; receiving a summary for each of the one or more candidate results; and providing the summary with the search results to the device associated with the user.

In some instances, the previously generated embeddings include embeddings generated by the AI model based on a title, data provider, and textual description of the available data.

In some instances, the metadata object describing the available data includes a title, data provider, cleartext of the embedding, and a data ID.

In some instances, the similarity search includes at least one of a Cosine Similarity search, a Euclidean Distance search, or a Maximal Marginal Relevance search between the query embeddings and the database of embeddings.

In some instances, converting the search query into a first AI prompt includes generating a command that calls an embedding function within the AI model and specifies the natural language text to be embedded.

In some instances, the AI model is a foundation AI model comprising a large language model.

The details of these and other aspects and embodiments of the present disclosure are set forth in the accompanying drawings and the description below. Other features, objects, and advantages of the disclosure will be apparent from the description, drawings, and claims.

### DESCRIPTION OF DRAWINGS

Some example embodiments of the present disclosure are illustrated by way of example and not limitation in the figures of the accompanying drawings, in which like reference numbers indicate similar elements.

FIG. 1 illustrates a schematic diagram of a system for performing intelligent datastore search using live embeddings.

FIG. 2 is a flowchart of an example process 200 for generating a datastore to be searched using live embeddings.

FIG. 3 is a flowchart of an example process 300 for performing intelligent datastore search using live embeddings.

FIG. 4 is a block diagram illustrating an example of a computer-implemented system.

### DETAILED DESCRIPTION

This disclosure describes methods, software, and systems for performing intelligent datastore search using live embeddings. In general, a datastore may include large quantities of individual data sets, which may in turn each include large amounts of data. To build a data model for predictive analysis, studies, or other solutions, engineers need to source relevant data. A data marketplace can be provided which allows users to purchase the data that they need, however, because there can be lots of disparate data sets within the data marketplace, each data set with varying degrees of description in varying formats, a smart search tool is necessary to enable users to quickly find data in which they are interested.

In general, this disclosure describes a solution for taking a user's natural language query, using a generative AI model to produce an embedding of that query, and then comparing that query embedding to a database of embeddings generated from metadata and data set descriptions of the datasets in the datastore. In addition to dataset, this solution and the associated database of embeddings can provide information for data catalogues and metadata catalogs. This database of embeddings includes both the embedding vectors, and a metadata object describing each data set in the datastore and is uniquely generated to enable efficient search application. Once comparison results are determined, the closest matching datasets to the user query can be provided to the AI model for a summarization of their contents, before being returned to the user as search results. In some implementations, the most relevant data column names of the data set are mentioned in the summary if present. In some implementations, suggested usage of the found data set is provided by the AI model.

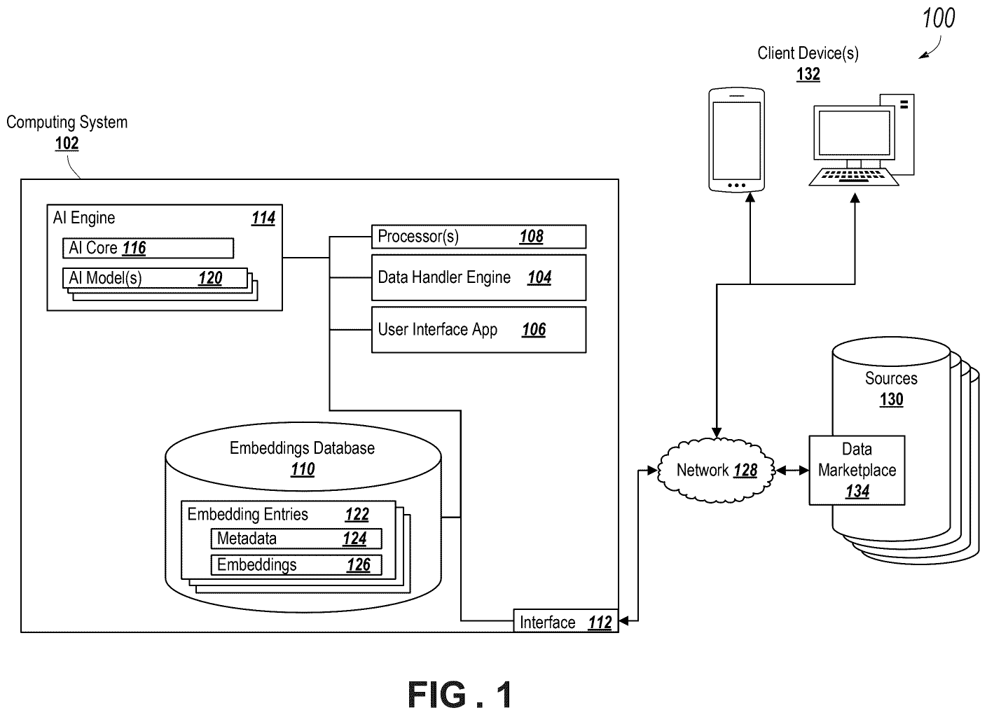

Turning to the illustrated example implementations, FIG. 1 illustrates a schematic diagram of a system 100 for performing intelligent datastore search using live embeddings. The system 100 includes a computing system 102, which can be a backend server system, or cluster of server systems, or can be an array of virtual servers provided by an enterprise computing platform. A group of data sources 130 form a datastore, from which a data marketplace 134 can provide data sets for modeling. One or more client devices 132 can interact with the computing system 102 and the data marketplace 134 using a network 128.

Network 128 facilitates wireless or wireline communications between the components of the system 100 (e.g., between the computing system 102, the client device(s) 132, and the data marketplace 134), as well as with any other local or remote computers, such as additional mobile devices, clients, servers, or other devices communicably coupled to network 128, including those not illustrated in FIG. 1. In the illustrated environment, the network 128 is depicted as a single network, but can comprise more than one network without departing from the scope of this disclosure, so long as at least a portion of the network 128 can facilitate communications between senders and recipients. In some instances, one or more of the illustrated components can be included within or deployed to network 128 or a portion thereof as one or more cloud-based services or operations. The network 128 can be all or a portion of an enterprise or secured network, while in another instance, at least a portion of the network 128 can represent a connection to the Internet. In some instances, a portion of the network 128 can be a virtual private network (VPN). Further, all or a portion of the network 128 can comprise either a wireline or wireless link. Example wireless links can include 802.11a/b/g/n/ac, 802.20, WiMax, LTE, and/or any other appropriate wireless link. In other words, the network 128 encompasses any internal or external network, networks, sub-network, or combination thereof operable to facilitate communications between various computing components inside and outside the illustrated system 100. The network 128 can communicate, for example, Internet Protocol (IP) packets, Frame Relay frames, Asynchronous Transfer Mode (ATM) cells, voice, video, data, and other suitable information between network addresses. The network 128 can also include one or more local area networks (LANs), radio access networks (RANs), metropolitan area networks (MANs), wide area networks (WANs), all or a portion of the Internet, and/or any other communication system or systems at one or more locations.

The data marketplace 134 includes a number of data sources 130, which can be local or remote to the marketplace 134 and can be stored in individual memories or shared memory. In some implementations, the sources 130 are stored and managed by third party external systems. They can be a part of a shared system which provides data warehousing, virtualization, and cataloging for many parties. The data marketplace 134 enables integration of data from multiple sources 130 and facilitates the exchange of that data between providers and consumers. In general, a customer can access a data product within the data marketplace, see a brief description of the data as well as some additional metadata such as number of files, file size, organizational hierarchy, title, etc. and upon selecting a data product (e.g., for purchase), the data product is then replicated within the user's system or otherwise made available for access to the user. The data product can further include sample data and images of sample data, as well as pdfs or other documents with extended description and documentation. In some implementations, the data product is a data catalogue, which represents a collection of data assets and data sets within the catalog.

Within a company's ecosystem, the data marketplace 134 can serve as a tool for internal data sharing, either for a selected audience or across one or several tenants. In addition, enterprises can use a private data exchange for collaboration. Data product owners can set the visibility of their products within the data marketplace 134 accordingly and invite selected users to access a space on their tenant or across multiple tenants, using a license key, enabling the data to be consumed by these authorized users.

Computing system 102 can interact with the data marketplace 134 using an interface 112. In general, the computing system 102 includes one or more processors 108, a data handler engine 104, a user interface application 106, an AI engine 114, and an embeddings database 110.

Interface 112 is used by the computing system 102 for communicating with other systems in a distributed environment—including within the system 100—connected to the network 128, e.g., client 132, and other systems communicably coupled to the illustrated computing system 102 and/or network 128. Generally, the interface 112 comprises logic encoded in software and/or hardware in a suitable combination and operable to communicate with the network 128 and other components. More specifically, the interface 112 can comprise software supporting one or more communication protocols associated with communications such that the network 128 and/or interface's 112 hardware is operable to communicate physical signals within and outside of the illustrated system 100. Still further, the interface 112 can allow the computing system 102 to communicate with the client 132, and data marketplace 134, and/or other portions illustrated within the system 100 to perform the operations described herein.

Although illustrated as a single processor 108 in FIG. 1, multiple processors can be used according to particular needs, desires, or particular implementations of the system 100. Each processor 108 can be a central processing unit (CPU), an application specific integrated circuit (ASIC), a field-programmable gate array (FPGA), or another suitable component. Generally, the processor 108 executes instructions and manipulates data to perform the operations of the computing system 102. Specifically, the processor 108 executes the algorithms and operations described in the illustrated figures, as well as the various software modules and functionality, including the functionality for sending communications to and receiving transmissions from client devices 132, data marketplace 134, as well as to other devices and systems. Each processor 108 can have a single or multiple cores, with each core available to host and execute an individual processing thread. Further, the number of, types of, and particular processors 108 used to execute the operations described herein can be dynamically determined based on a number of requests, interactions, and operations associated with the computing system 102.

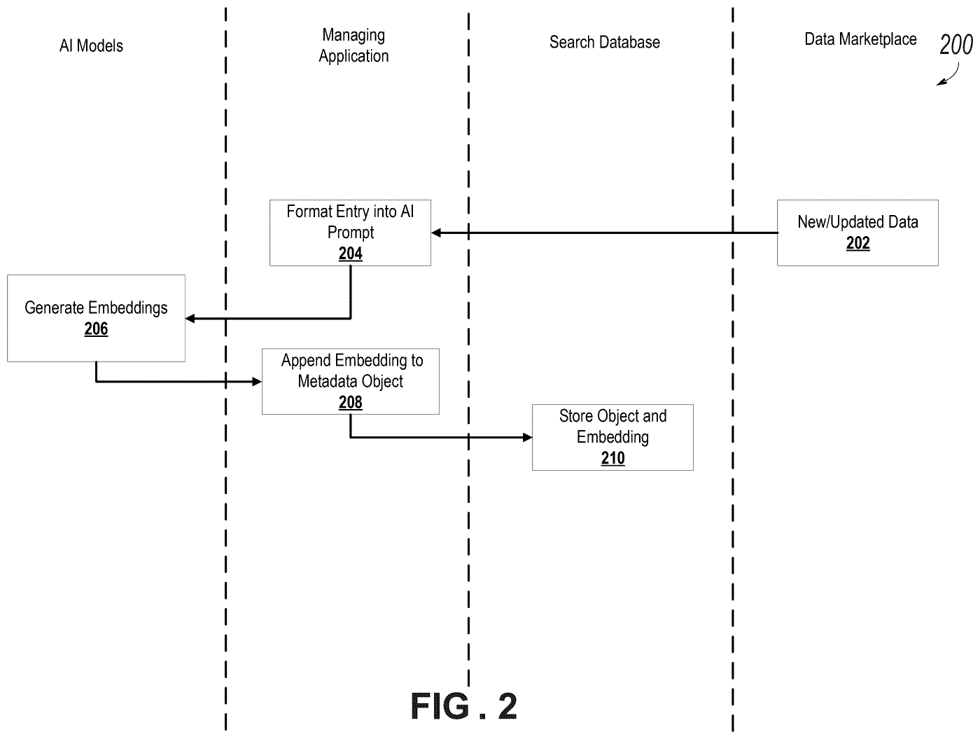

The data handler engine 104 uses the data product descriptions and information from the data marketplace 134 and generates embedding entries for storage and consumption within the embeddings database 110. To do this, the data handler engine 104 uses the AI engine 114, which can parse a natural language prompt and generate an embedding. In general, the data handler engine 104 uses an API or other mechanism (e.g., data scraping, crawling, etc.) to track new, updated, or deleted data products from the data marketplace 134. When a new data product is added or updated, or a data product is deleted from the data marketplace 134, the data handler engine 104 can update the embeddings database 110 accordingly. This process is described in more detail below with respect to FIG. 2.

Embeddings database 110 includes a number of embedding entries 122, each associated with a product in the data marketplace 134. Each embedding entry 122 includes metadata 124 and embeddings 126. The metadata 124 can be a separate data object and can be of a different data type than the embeddings 126. For example, the metadata 124 can be a JSON object which identifies a data provider, data product title, and a product ID. Metadata 124 can include other information such as data product size, date of creation, date of latest update, filetypes contained, etc. The embeddings 126 are a multi-dimensional vector that represents the data product. The embeddings 126 can be generated by the AI engine 114 at the request or command of the data handler engine 104, and can be based on the data provider, product title, and a textual description of the data product. In some implementations, the embeddings 126 are further generated based on image data associated with the product, advertising data, or other information.

Embeddings database 110 of the computing system 102 can be stored within a single memory or multiple memories. The embeddings database 110 can include any memory or database module and can take the form of volatile or non-volatile memory including, without limitation, magnetic media, optical media, random access memory (RAM), read-only memory (ROM), removable media, or any other suitable local or remote memory component. The memory 110 can store various objects or data, including digital asset data, public keys, user and/or account information, administrative settings, password information, caches, applications, backup data, repositories storing business and/or dynamic information, and any other appropriate information associated with the computing system 102, including any parameters, variables, algorithms, instructions, rules, constraints, or references thereto. Additionally, the embeddings database 110 can store any other appropriate data, such as VPN applications, firmware logs and policies, firewall policies, a security or access log, print or other reporting files, as well as others. While illustrated within the computing system 102, embeddings database 110 or any portion thereof, including some or all of the particular illustrated components, can be located remote from the computing system 102 in some instances, including as a cloud application or repository or as a separate cloud application or repository when the computing system 102 itself is a cloud-based system. In some instances, some or all of the embeddings database 110 can be located in, associated with, or available through one or more other systems of the associated enterprise software platform. In those examples, the data stored in embeddings database 110 can be accessible, for example, via one of the described applications or systems. In some implementations, the embeddings are stored within the embeddings database 110 as a vector of floating-point variables. In some implementations, other formats or data types are possible (e.g., strings, int32, etc.).

The AI engine 114 enables other engines and applications to interact with one or more AI models in a secure manner. That is, the AI engine 114 generally provides access to large-scale third-party model, while ensuring that data used in prompting those models, or training new models, remains in the custody of the computing system 102. The AI engine 114 can include an AI core 116 which manages prompts and training commands amongst an array of hosted AI models 120. In some implementations, AI models 120 can be hosted in a separate secure computational environment, and accessed using a standardized secure interface (e.g., and API).

The AI core 116 can constrain the AI models 120 by grounding their outputs to ensure they do not contain hallucinations. This can be accomplished, for example, with prompt engineering, in-context learning, and retrieval-augmented generation (RAG).

The AI models 120 can be foundation models that are used to generate a response to a given prompt. In some implementations, foundation models are large AI neural networks trained on large sets of unlabeled data, in some instances through self-supervised learning. These models, once trained, can perform specific tasks such as image classification, natural language processing, question answering, or embedding, among others. Embedding, for example, is generating a numerical representation of data in a lower-dimensional space to convert complex information, such as text, images, or audio, into a format that is more efficiently processed by computers. Example AI models 120 can include, but are not limited to, large language models (LLMs), Bidirectional encoder representations from Transformers (BERT), or other transformer-based networks.

The AI models 120 can be provided by a third party or external source, such as OpenAI, or Google, which can provide a base model with some foundational training. In some implementations, the AI core 116 enables users of the computing system 102 to provide their own AI models 120. In some implementations, users of the computing system 102 can take an AI model 120 and provide additional training or customization to that model to generate a new AI model 120 that is optimized to perform for that user's needs (e.g., trained on their data set, or restrained based on custom criteria).

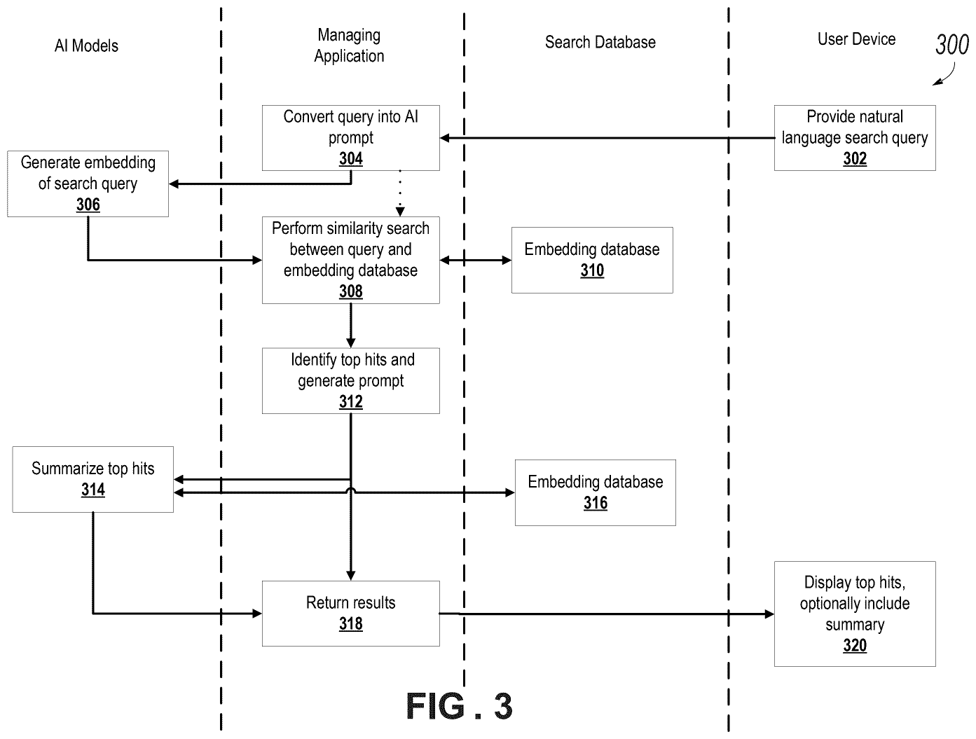

The user interface application 106 can be used to enable the user, via the client devices 132, to provide a search query. Client device(s) 132 can be mobile computing devices such as smartphones, laptops, tablets, or other devices, or fixed computing devices such as a desktop computer, kiosk, or other suitable device. The user interface application 106 can then use the AI engine to convert the search query to an embedding, which can be efficiently compared to the embeddings database 110 to generate a list of results. In general, the user interface application 106 manages user input and displays the top search results. The sequence can be triggered once a user enters a search term into the application's search bar. The search input is forwarded by the user interface app 106 to the same AI model 120, which can in some instances be an embedding model as was used to generate the embeddings within the embeddings database. Once the search query is converted into an embedding by an AI model 120, the user interface application 106 facilitates a similarity search using similarity methods within the embeddings database 110. In some implementations, the similarity search algorithm runs within an in-memory database, or by the data handler engine 104. In some implementations, the similarity search results are used as context in a second part of the workflow to generate a structured prompt template. A finished prompt based on the structured prompt template can be sent to the AI engine 114 which can select an AI model, such as GPT 3.5 or Claude, for example. The AI model 120 generates a summary for each of the top search results, and the user interface application 106 displays it to the user alongside the other details of the top data products. In some implementations, the generated summary is stored in the embeddings database when the entry is created. This summary can be retrieved for the data product when a similarity search is concluded. The user interface application 106 can enable the user to view the results and navigate to the linked data marketplace 134 site to read through the extended data product description. In some implementations, additional details such as pricing, sample data, and more can be explored alongside the functionality to acquire the suggested data product. A more detailed example of the process for performing a search using the user interface application 106 is described below with respect to FIG. 3.

While illustrated as separate, in some implementations both the user interface application 106 and the data handler engine 104 are combined in a single application. In some implementations, the user interface application 106 is a Gradio application. Gradio is an open-source Python library that enables building user interfaces for machine learning models, APIs, or any Python function.

FIG. 2 is a flowchart of an example process 200 for generating a datastore to be searched using live embeddings. It will be understood that process 200 and related methods may be performed, for example, by any suitable system, environment, software, and hardware, or a combination of systems, environments, software, and hardware, as appropriate. For example, a system comprising a communications module, at least one memory storing instructions and other required data, and at least one hardware processor interoperably coupled to the at least one memory and the communications module can be used to execute process 200. In some implementations, the process 200 and related methods are executed by one or more components of the system 100 described above with respect to FIG. 1, such as the computing system 102 and the customer data marketplace 134, and/or portions thereof.

At 202, new or updated data is provided to or generated within the data marketplace. This can represent a deletion of old data, introduction of entirely new data, or modification of existing data. In some implementations, an entirely new data product is introduced into the data marketplace. In some implementations, a data product, the data within that product, or its associated description and metadata is changed. In some implementations, the search database or managing application can access an API periodically that provides data marketplace updates or a list of new and updated data. Each data product within the data marketplace can include metadata including a title, provider, product ID, file type and size information, and other metadata, as well as the dataset itself, which can be a large volume of data stored in various formats.

At 204, the updated data is fetched by a managing application and converted into an AI prompt in order for an embedding to be generated. In some implementations, a structured prompt is used, with variable details filled in for each new embedding to be created. For example, a structured prompt with inputs of title, textual description, and provider can be generated. In some implementations, third party software is used to generate the prompt, such as LangChain, which can provide a unified interface for using various embedding models such as OpenAI, Cohere, models available on HuggingFace, or others.

At 206, an AI model receives the prompt from the managing application and generates an embedding. The embedding can be a multi-dimensional vector that succinctly represents the prompt (e.g., the title, provider, and textual description) in a numerical format.

At 208, the embedding is appended to a metadata object to create a database table. In some implementations, the metadata object is a JSON that includes documentation associated with the data product. The metadata object can include the cleartext textual description, as well as other information about the data product, and the embedding includes the numerical representation of that product. For example, this additional information can be recorded in a separate column of the same row as the embedding.

At 210, the metadata object and appended embedding are stored in a search database. The search database can maintain entries for a large number of data products within the data marketplace, each entry including a metadata object and associated embedding. In some implementations, the search database does not contain the actual data itself, which is instead stored in the by data providers to the data marketplace. This reduces the amount of storage space required and improves the access speed and search speed capabilities of the search database.

FIG. 3 is a flowchart of an example process 300 for performing intelligent datastore search using live embeddings. It will be understood that process 300 and related methods may be performed, for example, by any suitable system, environment, software, and hardware, or a combination of systems, environments, software, and hardware, as appropriate. For example, a system comprising a communications module, at least one memory storing instructions and other required data, and at least one hardware processor interoperably coupled to the at least one memory and the communications module can be used to execute process 300. In some implementations, the process 300 and related methods are executed by one or more components of the system 100 described above with respect to FIG. 1, such as the computing system 102, the customer data marketplace 134, client devices 132, and/or portions thereof.

At 302, a natural language search query is provided from a user device to a managing application. The natural language query can be a search for data of a specific type or related to a specific category. Examples of natural language search queries can be “diet-friendly food product information,” “business laptops,” or “cellular device use amongst teenagers.” In some implementations, the search query can be phrases or keywords as shown above, in other implementations the search query can be full sentences. Either can be provided by the user device and processed.

At 304, the natural language query is converted into an AI prompt. Similarly to 204 above, the managing application can use a structured prompt, inputting certain data fields from the query to generate an AI prompt. In some implementations, third party interface software such as LangChain is used to request an embedding from the AI model. In some implementations, additional context is added to the AI prompt in addition to the search query. Additional context can be, for example, recent search queries from the same user, the current local time and date, weather conditions, or applications executing within the search system or on the user device, among other external context.

At 306, an AI model generates an embedding of the search query based on the AI prompt. In some implementations, the AI model that embeds the search query is the same AI model, using the same process, which embedded the data for the search database. This ensures that similar search queries will be embedded similarly to data products describing similar terms. By using the same embedding model for both the search query and the data loading, the embedding database can be efficiently searched using the embeddings and the search query.

At 308, a similarity search is performed between the embedding of the search query, and embeddings within an embeddings database (310). This search can use a mathematical similarity algorithm or combination of algorithms such as a cosine similarity search, Euclidean distance search, maximal marginal relevance (MMR) search, reciprocal rank fusion (RRF) search, or other suitable algorithms. In some implementations, the cleartext natural language from the user device input is also provided, and the embeddings database is searched using that language in addition to, or in parallel with, the similarity search.

At 312, the top hits, or most likely candidate results, are identified from the search. The managing application can send a product ID, title, or other information to one or more AI models for summarization. In some implementations, the top hits are ranked based on similarity. In some implementations, the top hits are ranked based on additional factors, such as popularity or ratings associated with the data product, data product size, product provider (e.g., some providers may be preferred) or other criterion.

At 314, an AI model is used to analyze, from the embeddings database (316), the top hits or data products associated with the product ID provided from the management application. The AI model generates a summary of the top hits, which can provide readily consumable information for the user. In some implementations the AI model used to summarize the data products is GPT 3.5 Turbo. In some implementations, other AI models are used, and can be updated or replaced as the models improve. In some implementations, instead of analyzing and performing a new summary, a separate database of summaries is archived. When a data product is returned by a search for a second or multiple times, the stored or archived summary can be used, preventing the need for a separate call and inference by the AI model and reducing overall computational cost.

At 318, the search results, including summaries are prioritized and returned to the user. The search results can also include suggested use cases, and identified key data columns within the returned data.

At 320, a user device can display the top hits, including the summary for each hit. The user operating the user device can access a graphical user interface and drill down, or further investigate any returned hit, as well as modify the search query and initiate a new search. In some implementations, a link or URL for each displayed result is included which directs the user to the corresponding external data set. If a new search is initiated, the new search can retain as context the previously conducted search.

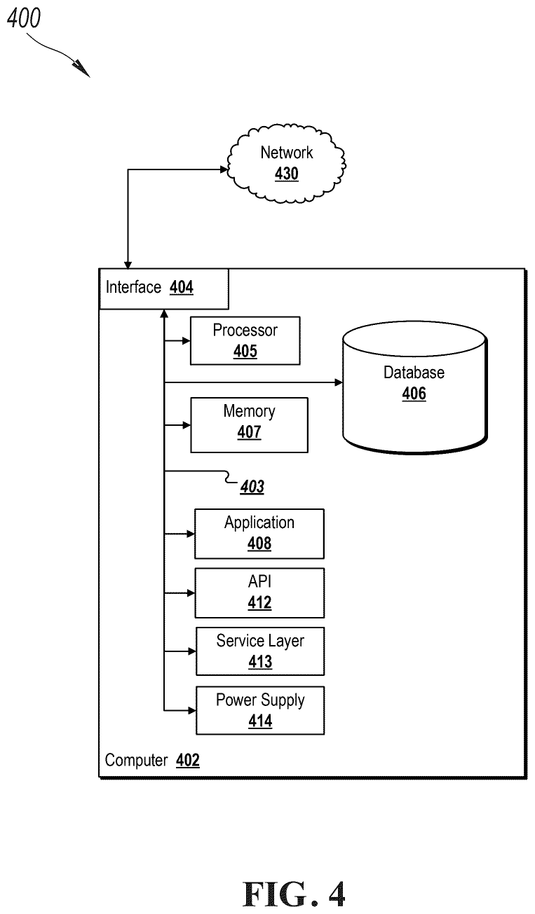

FIG. 4 is a block diagram illustrating an example of a computer-implemented system. 400 used to provide computational functionalities associated with described algorithms, methods, functions, processes, flows, and procedures, according to an implementation of the present disclosure. In the illustrated implementation, system 400 includes a computer 402 and a network 430.

The illustrated computer 402 is intended to encompass any computing device, such as a server, desktop computer, laptop/notebook computer, wireless data port, smart phone, personal data assistant (PDA), tablet computer, one or more processors within these devices, or a combination of computing devices, including physical or virtual instances of the computing device, or a combination of physical or virtual instances of the computing device. Additionally, the computer 402 can include an input device, such as a keypad, keyboard, or touch screen, or a combination of input devices that can accept user information, and an output device that conveys information associated with the operation of the computer 402, including digital data, visual, audio, another type of information, or a combination of types of information, on a graphical-type user interface (UI) (or GUI) or other UI.

The computer 402 can serve in a role in a distributed computing system as, for example, a client, network component, a server, or a database or another persistency, or a combination of roles for performing the subject matter described in the present disclosure. The illustrated computer 402 is communicably coupled with a network 430. In some implementations, one or more components of the computer 402 can be configured to operate within an environment, or a combination of environments, including cloud-computing, local, or global.

At a high level, the computer 402 is an electronic computing device operable to receive, transmit, process, store, or manage data and information associated with the described subject matter. According to some implementations, the computer 402 can also include or be communicably coupled with a server, such as an application server, e-mail server, web server, caching server, or streaming data server, or a combination of servers.

The computer 402 can receive requests over network 430 (for example, from a client software application executing on another computer 402) and respond to the received requests by processing the received requests using a software application or a combination of software applications. In addition, requests can also be sent to the computer 402 from internal users (for example, from a command console or by another internal access method), external or third-parties, or other entities, individuals, systems, or computers.

Each of the components of the computer 402 can communicate using a system bus 403. In some implementations, any or all of the components of the computer 402, including hardware, software, or a combination of hardware and software, can interface over the system bus 403 using an application programming interface (API) 412, a service layer 413, or a combination of the API 412 and service layer 413. The API 412 can include specifications for routines, data structures, and object classes. The API 412 can be either computer-language independent or dependent and refer to a complete interface, a single function, or even a set of APIs. The service layer 413 provides software services to the computer 402 or other components (whether illustrated or not) that are communicably coupled to the computer 402. The functionality of the computer 402 can be accessible for all service consumers using the service layer 413. Software services, such as those provided by the service layer 413, provide reusable, defined functionalities through a defined interface. For example, the interface can be software written in a computing language (for example, JAVA or C++) or a combination of computing languages and providing data in a particular format (for example, extensible markup language (XML)) or a combination of formats. While illustrated as an integrated component of the computer 402, alternative implementations can illustrate the API 412 or the service layer 413 as stand-alone components in relation to other components of the computer 402 or other components (whether illustrated or not) that are communicably coupled to the computer 402. Moreover, any or all parts of the API 412 or the service layer 413 can be implemented as a child or a sub-module of another software module, enterprise application, or hardware module without departing from the scope of the present disclosure.

The computer 402 includes an interface 404. Although illustrated as a single interface 404, two or more interfaces 404 can be used according to particular needs, desires, or particular implementations of the computer 402. The interface 404 is used by the computer 402 for communicating with another computing system (whether illustrated or not) that is communicatively linked to the network 430 in a distributed environment. Generally, the interface 404 is operable to communicate with the network 430 and includes logic encoded in software, hardware, or a combination of software and hardware. More specifically, the interface 404 can include software supporting one or more communication protocols associated with communications such that the network 430 or hardware of interface 404 is operable to communicate physical signals within and outside of the illustrated computer 402.

The computer 402 includes a processor 405. Although illustrated as a single processor 405, two or more processors 405 can be used according to particular needs, desires, or particular implementations of the computer 402. Generally, the processor 405 executes instructions and manipulates data to perform the operations of the computer 402 and any algorithms, methods, functions, processes, flows, and procedures as described in the present disclosure.

The computer 402 also includes a database 406 that can hold data for the computer 402, another component communicatively linked to the network 430 (whether illustrated or not), or a combination of the computer 402 and another component. For example, database 406 can be an in-memory or conventional database storing data consistent with the present disclosure. In some implementations, database 406 can be a combination of two or more different database types (for example, a hybrid in-memory and conventional database) according to particular needs, desires, or particular implementations of the computer 402 and the described functionality. Although illustrated as a single database 406, two or more databases of similar or differing types can be used according to particular needs, desires, or particular implementations of the computer 402 and the described functionality. While database 406 is illustrated as an integral component of the computer 402, in alternative implementations, database 406 can be external to the computer 402. The database 406 can hold any data type necessary for the described solution.

The computer 402 also includes a memory 407 that can hold data for the computer 402, another component or components communicatively linked to the network 430 (whether illustrated or not), or a combination of the computer 402 and another component. Memory 407 can store any data consistent with the present disclosure. In some implementations, memory 407 can be a combination of two or more different types of memory (for example, a combination of semiconductor and magnetic storage) according to particular needs, desires, or particular implementations of the computer 402 and the described functionality. Although illustrated as a single memory 407, two or more memories 407 or similar or differing types can be used according to particular needs, desires, or particular implementations of the computer 402 and the described functionality. While memory 407 is illustrated as an integral component of the computer 402, in alternative implementations, memory 407 can be external to the computer 402.

The application 408 is an algorithmic software engine providing functionality according to particular needs, desires, or particular implementations of the computer 402, particularly with respect to functionality described in the present disclosure. For example, application 408 can serve as one or more components, modules, or applications. Further, although illustrated as a single application 408, the application 408 can be implemented as multiple applications 408 on the computer 402. In addition, although illustrated as integral to the computer 402, in alternative implementations, the application 408 can be external to the computer 402.

The computer 402 can also include a power supply 414. The power supply 414 can include a rechargeable or non-rechargeable battery that can be configured to be either user- or non-user-replaceable. In some implementations, the power supply 414 can include power-conversion or management circuits (including recharging, standby, or another power management functionality). In some implementations, the power supply 414 can include a power plug to allow the computer 402 to be plugged into a wall socket or another power source to, for example, power the computer 402 or recharge a rechargeable battery.

There can be any number of computers 402 associated with, or external to, a computer system containing computer 402, each computer 402 communicating over network 430. Further, the term “client,” “user,” or other appropriate terminology can be used interchangeably, as appropriate, without departing from the scope of the present disclosure. Moreover, the present disclosure contemplates that many users can use one computer 402, or that one user can use multiple computers 402.

This detailed description is merely intended to teach a person of skill in the art further details for practicing certain aspects of the present teachings and is not intended to limit the scope of the claims. Therefore, combinations of features disclosed above in the detailed description may not be necessary to practice the teachings in the broadest sense, and are instead taught merely to describe particularly representative examples of the present teachings.

Unless specifically stated otherwise, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. A computer implemented method comprising:
receiving a search query in a natural language from a device associated with a user;
converting the search query to a first artificial intelligence (AI) prompt comprising a command that calls an embedding function within an AI model, wherein the AI prompt specifies natural language text to be embedded, and wherein embedding natural language text converts the natural language text to a multi-dimensional vector;
sending the AI prompt to an AI model;
receiving, from the AI model, a query embedding representing the search query;
performing a similarity search between the query embedding and a database of embeddings to identify one or more candidate results, wherein the database of embeddings comprises a plurality of entries, each entry comprising a metadata object describing available data stored at a data source, and a previously generated embedding representing the available data;
selecting, from the one or more candidate results, a search result; and
sending the search result to the device associated with the user, wherein the search results comprise a link to the available data stored at the data source.

2. The method of claim 1, comprising:
sending a data identification (ID) from the metadata object for each of the one or more candidate results and a second AI prompt to the AI model;
receiving a summary for each of the one or more candidate results; and
providing the summary with the search results to the device associated with the user.

3. The method of claim 1, wherein the previously generated embeddings comprise embeddings generated by the AI model based on a title, data provider, and textual description of the available data.

4. The method of claim 1, wherein the metadata object describing the available data comprises a title, data provider, cleartext of the embedding, and a data identification (ID).

5. The method of claim 1, wherein the similarity search comprises at least one of, a Cosine Similarity search, a Euclidean Distance search, or a Maximal Marginal Relevance search between the query embeddings and the database of embeddings.

6. (canceled)

7. The method of claim 1, wherein the AI model is a foundation AI model comprising a large language model.

8. A non-transitory, computer-readable medium storing one or more instructions executable by a computer system to perform operations comprising:
receiving a search query in a natural language from a device associated with a user;
converting the search query to a first artificial intelligence (AI) prompt comprising a command that calls an embedding function within an AI model, wherein the AI prompt specifies natural language text to be embedded, and wherein embedding natural language text converts the natural language text to a multi-dimensional vector;
sending the AI prompt to an AI model;
receiving, from the AI model, a query embedding representing the search query;
performing a similarity search between the query embedding and a database of embeddings to identify one or more candidate results, wherein the database of embeddings comprises a plurality of entries, each entry comprising a metadata object describing available data stored at a data source, and a previously generated embedding representing the available data;
selecting, from the one or more candidate results, a search result; and
sending the search result to the device associated with the user, wherein the search results comprise a link to the available data stored at the data source.

9. The medium of claim 8, comprising:
sending a data identification (ID) from the metadata object for each of the one or more candidate results and a second AI prompt to the AI model;
receiving a summary for each of the one or more candidate results; and
providing the summary with the search results to the device associated with the user.

10. The medium of claim 8, wherein the previously generated embeddings comprise embeddings generated by the AI model based on a title, data provider, and textual description of the available data.

11. The medium of claim 8, wherein the metadata object describing the available data comprises a title, data provider, cleartext of the embedding, and a data identification (ID).

12. The medium of claim 8, wherein the similarity search comprises at least one of, a Cosine Similarity search, a Euclidean Distance search, or a Maximal Marginal Relevance search between the query embeddings and the database of embeddings.

13. (canceled)

14. The medium of claim 8, wherein the AI model is a foundation AI model comprising a large language model.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
receiving a search query in a natural language from a device associated with a user;
converting the search query to a first artificial intelligence (Al) prompt comprising a command that calls an embedding function within an AI model, wherein the AI prompt specifies natural language text to be embedded, and wherein embedding natural language text converts the natural language text to a multi-dimensional vector;
sending the AI prompt to an AI model;
receiving, from the AI model, a query embedding representing the search query;
performing a similarity search between the query embedding and a database of embeddings to identify one or more candidate results, wherein the database of embeddings comprises a plurality of entries, each entry comprising a metadata object describing available data stored at a data source, and a previously generated embedding representing the available data;
selecting, from the one or more candidate results, a search result; and
sending the search result to the device associated with the user, wherein the search results comprise a link to the available data stored at the data source.

16. The system of claim 15, comprising:
sending a data identification (ID) from the metadata object for each of the one or more candidate results and a second AI prompt to the AI model;
receiving a summary for each of the one or more candidate results; and
providing the summary with the search results to the device associated with the user.

17. The system of claim 15, wherein the previously generated embeddings comprise embeddings generated by the AI model based on a title, data provider, and textual description of the available data.

18. The system of claim 15, wherein the metadata object describing the available data comprises a title, data provider, cleartext of the embedding, and a data identification (ID).

19. The system of claim 15, wherein the similarity search comprises at least one of, a Cosine Similarity search, a Euclidean Distance search, or a Maximal Marginal Relevance search between the query embeddings and the database of embeddings.

20. (canceled)
